(19) United States
(12) Patent Application Publication
(10) Pub. No.: US 2016/0005111 A1
(43) Pub. Date: Jan. 7, 2016

(54) SYSTEM AND METHOD FOR COMPLYING WITH SOLVENCY REGULATIONS

(71) Applicant: Wipro Limited, Bangalore (IN)

(72) Inventors: Rahul Krishna Deshpande, Bangalore (IN); Muthuselvam Chandramohan, Chennai (IN); Prasanth Thoppil Sivasankaran, Trivandrum (IN)

(21) Appl. No.: 14/474,519

(22) Filed: Sep. 2, 2014

(30) Foreign Application Priority Data
Jul. 7, 2014 (IN) 3344/CHE/2014

(51) Int. Cl. G06Q 40/00

(52) U.S. Cl. CPC G06Q 40/00

(57) ABSTRACT

Apparatuses, methods, and non-transitory computer readable media for complying with solvency regulations of one or more jurisdictions are described herein. In one example, the method, for complying with solvency regulations of one or more jurisdictions, comprises classifying financial data based on type of risk associated with the data and performing solvency gateway checks, based on solvency rules, to determine validity of the classified data for determination of risk. The method further comprises aggregating the validated data based on at least one aggregation level and computing the solvency risk, based on risk computation rules, associated with the aggregated data.

This application claims the benefit of Indian Patent Application Serial No. 3344/CHE/2014 filed Jul. 7, 2014, which is hereby incorporated by reference in its entirety.

### FIELD

This technology relates to compliance systems, and, particularly but not exclusively, to apparatuses and methods for compliance with solvency regulations of one or more jurisdictions.

### BACKGROUND

Solvency II is a set of insurance regulations for the 27 member states of the European Union, which mandates insurers to demonstrate they have robust risk and capital management strategies in place and imposes new corporate governance and reporting requirements on companies. The regulations seek to protect policyholders, ensure that the industry can withstand economic shocks, and protect the viability and stability of the economy in Europe. Other jurisdictions, such as the United States of America and Australia, are considering similar legislations for almost the same purpose.

Many industry experts and analysts are of the opinion that Solvency II is not just a European insurance industry issue; it affects the entire global buy-side value chain. For example, whenever an insurance company outsources asset management to a third party investment manager, that investment manager may need to provide much of the data that the insurance company needs to meet its regulatory obligations. In turn, the asset servicing firms (such as custodian banks and fund administrators) that support the asset manager also will be called on to provide critical data inputs required by Solvency II. Thus, insurers, reinsurers and captive owners are facing enormous challenges in preparing for Solvency II or similar legislations of other jurisdictions.

### SUMMARY

Disclosed herein are apparatus and methods for complying with solvency regulations of one or more jurisdictions.

In an aspect of the invention, the method, for complying with solvency regulations of one or more jurisdictions, comprises classifying financial data based on type of risk associated with the data and performing solvency gateway checks, based on solvency rules, to determine validity of the classified data for determination of risk. The method further comprises aggregating the validated data based on at least one aggregation level and computing the solvency risk, based on risk computation rules, associated with the aggregated data.

In another aspect of the invention, a solvency compliance computing device that complies with solvency regulations of one or more jurisdictions is described herein. The solvency compliance computing device comprises a processor, a memory communicatively coupled to the processor, wherein the memory stores processor-executable instructions, which, on execution, cause the processor to classify financial data based on type of risk associated with the data, and perform solvency gateway checks, based on solvency rules, to determine validity of the classified data for determination of risk. The instructions, on execution, further cause the processor to aggregate the validated data based on at least one aggregation level, and compute the solvency risk, based on risk computation rules, associated with the aggregated data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a network environment incorporating a solvency compliance computing device that complies with solvency regulations of one or more jurisdictions, according to some embodiments of the present subject matter.

FIG. 2 illustrates an exemplary computer implemented method for complying with solvency regulations of one or more jurisdictions, according to some embodiments of the present subject matter.

FIG. 3 is a block diagram of an example of a solvency compliance computing device that implements this technology as illustrated and described herein.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in non-transitory computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Apparatuses, methods, and non-computer readable media for complying with solvency regulations of one or more jurisdictions are described herein. The devices and methods may be implemented in a variety of computing devices. The computing devices that can implement the described method(s) include, by way of example only, a server, a desktop personal computer, a notebook or a portable computer, a mainframe computer, and in a mobile computing environment. Although the description herein is with reference to certain computing devices, the devices and methods may be implemented in other computing devices, albeit with a few variations, as will be understood by a person skilled in the art.

Complying with Solvency II regulations and/or similar legislations of other jurisdictions present a number of complex data challenges for insurers and their service providers. For example: Insurers' Minimum Capital Requirement (MCR), Solvency Capital Requirement (SCR) calculations and risk reporting are highly dependent on accurate and regular asset and liability valuations, based on market prices for liquid instruments and evaluated prices for harder-to-value securities. Further, to conduct internal valuations, a range of underlying market and economic data is required, such as Solvency II-specific benchmark curves, rates and surfaces used to aggregate, model and manage cash flows. Regulators also seek transparency into the valuation methodologies, with a clear connection between the data inputs and price outputs.

Additionally, various securities, issuer, sector and ratings classification data are essential to understand the attributes/risk profile of the securities held by the insurer, and the issuers concerned. These include Complementary Identification Codes (CIC) for instrument and asset class definitions, Legal Entity Identifiers (LEI) to uniquely identify issuers and counterparties, Nomenclature statistique des activités économiques dans la Communautéeuropéenne (NACE) to define the business sector of companies held in insurance portfolios.

The regulations further have to implement Quantitative Report Template (QRT) which involves sourcing and mapping the correct data to populate the primary disclosure template (the QRT). This in itself will pose a huge challenge for most insurance firms. Not only will the QRT require the proper mapping and data inputs, but firms also will need appropriate controls that provide an audit trail and provenance of securities and portfolio data. Errors or omissions, of which there is a high risk, will likely result in regulators demanding additional ad hoc reporting, or even supplementary capital requirements where a firm's disclosures are deemed unsatisfactory.

Further, the data which has to be evaluated for compliance spans a host of categories, including instrument, issuer, classification (e.g., issuer, sector), geography, ratings, risk and fair value price. It then needs to be formatted consistently and mapped to the QRT, with transparency into the data's source.

Compliance with Solvency II requirements also needs sourcing timely and accurate constituent data across multiple fund portfolios. The fund holdings content also needs enriching with additional security-level information, such as CIC codes and other industry classifications, if firms are to aggregate their risk exposures accurately. Insurers who work with multiple asset managers face another burden of aggregating data from all of their asset managers, which may be provided in different formats, thus requiring added work to standardize.

In order to make the credit risk associated with investments transparent, insurers must include a Credit Quality Steps (CQS) number in their regulatory reports. Usually the CQS is based on ratings from the three major agencies (currently Moody's, Fitch and S&P), with the second-best value used for the SCR calculation and reporting. However, sourcing ratings from all three agencies involves substantial cost and requires end user firms to acquire the appropriate license from the agencies for this calculation to be performed. In addition, running the CQS analytics takes significant IT and data management overhead and effort.

Thus, the challenges industry participants will face are tremendous. Some industry experts feel that a collaborative approach, built on partnerships between data vendors, analytics providers, ratings agencies, asset servicers and the insurers themselves, will be essential for insurance firms to meet the disclosure requirements of Solvency II.

The present subject matter discloses apparatuses, methods, and non-transitory computer readable media for novel approaches for improving compliance with solvency regulations of one or more jurisdictions, such as the Solvency II regulations of Europe, which have not been considered before. In one example, the methods for complying with solvency regulations of one or more jurisdictions are implemented using a solvency compliance computing device configured to execute programmed instructions for the technology as illustrated and described with the technology herein. With this technology the functioning of the solvency compliance computing device with other types and/or numbers of other servers, computing devices, and/or databases in managing compliance is improved. By way of example only, the solvency compliance computing device may be implemented as a server, a desktop personal computer, a notebook or a portable computer, a mainframe computer, and in a mobile computing environment and so on. The solvency compliance computing device may also include other portable computing devices which are capable of communicating with communication networks. In one example, the solvency compliance computing device may be implemented in the existing financial data management systems of the organization. The organization may include any firm or entity which has to comply with Solvency II regulations or has to support a third party organization to enable the third party organization to comply with Solvency II regulations.

In operation, the functioning of the solvency compliance computing device is improved to more effectively obtain data from various financial systems of the organization and/or from third parties, such as investment partners, to manage solvency compliance. By way of example only, in some embodiments, the solvency compliance computing device generates a canonical interface to facilitate obtaining of data from various verticals of the organization's business. It would be appreciated by the readers that the relevant attributes vary from one vertical of the business to another. For example, the attributes for a health policy will be mortality, longevity and so on, whereas for home insurance, the attributes may be geography, weather conditions and so on. Thereafter, the function of the solvency compliance computing device is improved to more effectively classify or segregate the data based on the type of risks associated for the solvency compliance. In one example, the solvency compliance computing device may generate various extract, transform, and load (ETL) jobs that may provide the interface to segregate the data based on the type of risks, such as market risks, counterparty default risk, life underwriting, non-life underwriting risk, health underwriting risk, operation risk, and asset liability management risk.

Thereafter, the function of the solvency compliance computing device is improved to execute the solvency gateway checks. In some embodiments, the solvency compliance computing device verifies the data against the Solvency II rule repository to check if the data is qualified for a risk calculation. The Solvency II rule repository may be understood to be a collection of rules that are prepared, focusing from the business perspective, to run the pre-requisites checks that might be applicable for the risk calculations.

In some embodiments, the solvency compliance computing device stores the data, which is subject to risks as determined by the solvency gateway checks, in operational data store. The operational data store may be understood to be a type of database that's often used as an interim logical area for a data warehouse. While stored in the operational data store, data can be scrubbed, resolved for redundancy and checked for compliance with the corresponding business rules. The operational data store may also be used for integrating disparate data from multiple sources so that business operations, analysis and reporting can be carried out while business operations are occurring. In one example, the structure of the operational data storage may same as that of the structure of the interface. The data from the operational data store may also be useful for ad-hoc and supervisory control reporting.

In a sequential or parallel operation, the solvency compliance computing device aggregates the data in the operational data storage at various aggregation levels. The aggregation levels may be at the level business unit or at the level of legal entity or at the level of risk type or at the level of business vertical. In one example, the solvency compliance computing device may perform or execute various ET jobs to aggregate the data.

Thereafter, the solvency compliance computing device loads the aggregated data into a solvency data mart which is designed specifically for Solvency II reporting. The solvency data mart transforms the raw input and output of the risk calculation into a Solvency II reporting model that is designed for the Solvency II reporting. In some embodiments, the Solvency II reporting model is may be based on the subject areas identified by the reporting requirements, such as balance sheet, premiums, claims, expenditure, own funds, participation structure, change analysis, minimum capital requirement (MCR) and a solvency capital requirement (SCR), assets, technical provisions, reinsurance and profit or loss sharing. The categorization of the reports based on its subject area supports efficient risk calculations and parallel reporting in a faster manner. Further, iterative calculations and reporting for individual subject areas can be accomplished.

In some embodiments, the solvency compliance computing device generates a schematic layer on top of the solvency data mart to provide the end users to generate ad-hoc reports. The schematic layer provides the dimensions and fact attributes from the solvency data mart.

Thereafter, the solvency compliance computing device generates Solvency II reports, from the schematic layer. In some embodiments, the solvency compliance computing device generates Solvency II reports based on the templates provided by the end users and/or by the regulators. In one example, the generated reports may have multiple tabs, wherein each tab represents the individual subject areas. In one example, the solvency compliance computing device converts the generated report(s) into an eXtensible Business Reporting Language (XBRL) format for public disclosure.

Thus, examples of this technology improve the functioning of a computing apparatus to provide a comprehensive device for complying with solvency requirements of a jurisdiction. The present technology provides a technological solution to the problem of in preparing for Solvency II or similar legislations of other jurisdictions and the complex data challenges that will be faced by insurers and their service providers.

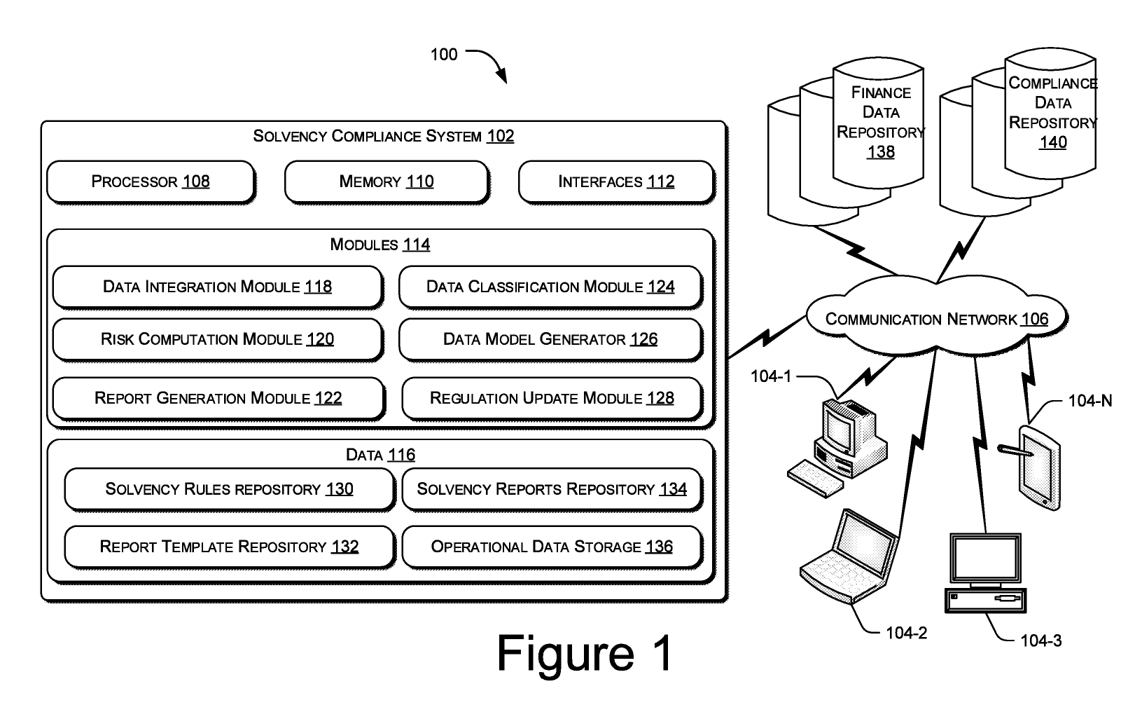

The working of the systems and methods for complying with solvency regulations of one or more jurisdictions is described in greater detail in conjunction with FIG. 1-3. It should be note that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates a network environment 100 incorporating a solvency compliance computing device 102 for complying with solvency regulations of one or more jurisdictions, according to some embodiments of the present subject matter. In one implementation, the solvency compliance computing device 102 may be implemented as a server, a desktop personal computer, a notebook or a portable computer, a mainframe computer, and in a mobile computing environment and so on. The solvency compliance computing device 102 may also include other portable computing devices which are capable of communicating with communication networks. In one example, the solvency compliance computing device 102 may be implemented in the existing financial data management systems, such as risk management platforms and compliance management systems, of the organization.

In one implementation, the solvency compliance computing device 102 includes a processor 108, a memory 110 coupled to the processor 108 and interfaces 112. The processor 102 may be implemented as one or more microprocessors, microcomputers, microcontrollers, digital signal processors, central processing units, state machines, logic circuitries, and/or any devices that manipulate signals based on operational instructions. Among other capabilities, the processor 102 is configured to fetch and execute computer-readable instructions stored in the memory 110. The memory 110 can include any non-transitory computer-readable medium known in the art including, for example, volatile memory (e.g., RAM), and/or non-volatile memory (e.g., EPROM, flash memory, etc.).

The interface(s) 112 may include a variety of software and hardware interfaces, for example, a web interface, a graphical user interface, etc., allowing the solvency compliance computing device 102 to interact with other computing devices. Further, the interface(s) 112 may enable the solvency compliance computing device 102 to communicate with other computing devices, The interface(s) 112 can facilitate multiple communications within a wide variety of networks and protocol types, including wired networks, for example LAN, cable, etc., and wireless networks such as WLAN, cellular, or satellite. The interface(s) 112 may include one or more ports for connecting a number of devices to each other or to another server.

In one example, the solvency compliance computing device 102 includes modules 114 and data 116. In one embodiment, the modules 114 and the data 116 may be stored within the memory 110. In one example, the modules 114, amongst other things, include routines, programs, objects, components, and data structures, which perform particular tasks or implement particular abstract data types. The modules 114 may also be implemented as, signal processor(s), state machine(s), logic circuitries, and/or any other device or component that manipulate signals based on operational instructions. Further, the modules 114 can be implemented by one or more hardware components, by computer-readable instructions executed by a processing unit, or by a combination thereof.

In one implementation, the modules 114 further include data integration module 118, risk computation module 120, report generation module 122, data classification module 124, data model generator 126, regulation update module 128, and other modules (not shown in figure). The other modules may perform various miscellaneous functionalities of the solvency compliance computing device 102. It will be appreciated that such aforementioned modules may be represented as a single module or a combination of different modules.

In one example, the data 116 serves, amongst other things, as a repository for storing data fetched, processed, received and generated by one or more of the modules 114. In some embodiment, the data 116 may be stored in the memory 110 in the form of various data structures. Additionally, the aforementioned data can be organized using data models, such as relational or hierarchical data models. The data 116 may be used to store data, including temporary data and temporary files, generated by the modules 114 for performing the various functions of the solvency compliance computing device 102. In one example, the data 116 includes solvency rules repository 130, report template repository 132, solvency reports repository 134, and operational data storage 136.

In operation, the data integration module 118 of the solvency compliance computing device 102 obtains data from various financial systems of the organization and/or from third parties, such as investment partners. In one example, the data integration module 118 may access the data repositories associated with the various financial systems to retrieve the data. In some embodiments, the data integration module 118 may generate a canonical interface to facilitate obtaining of data from various verticals of the organization's business.

Thereafter, the data classification module 124 classifies or segregates the data based on the type of risks associated for the solvency compliance. In one example, the data classification module 124 may generate various extract, transform, and load (ETL) jobs that may provide the interface to segregate the data based on the type of risks, such as market risks, counterparty default risk, life underwriting, non-life underwriting risk, health underwriting risk, operation risk, and asset liability management risk. In some embodiments, the data classification module 124 retrieves data classification rules from the solvency rules repository 130 to identify the risks associated with the data. In one example, the risk associated with the data may be dependent on the jurisdiction to whose regulations the compliance is sought.

Thereafter, the risk computation module 120 executes the solvency gateway checks, such as to calculate the credit risk, probability of default parameter cannot be null. In some embodiments, the risk computation module 120 verifies the data against the Solvency II compliance rules, stored in the solvency rules repository 130, to check if the data is qualified for a risk calculation. The Solvency II rules may be understood to be a collection of rules that are prepared, focusing from the business perspective, to run the pre-requisites checks that might be applicable for the risk calculations.

In some embodiments, in a parallel or sequential operation, the data model generator 126 stores the data, which is subject to risks as determined by the solvency gateway checks, in operational data store, which may be stored in the operational data storage 136. The operational data store may be understood to be a type of database that's often used as an interim logical area for a data warehouse. While stored in the operational data store, the data model generator 126 may scrub the data, resolve redundancies, and check the data for compliance with the corresponding business rules. The data model generator 126 may use the operational data store for integrating disparate data from multiple sources so that business operations, analysis and reporting can be carried out while business operations are occurring. In one example, the structure of the operational data storage may same as that of the structure of the interface. The data from the operational data store may also be useful for ad-hoc and supervisory control reporting.

In a sequential or parallel operation, the risk computation module 120 aggregates the data in the operational data storage at various aggregation levels. In various examples, the risk computation module 120 may aggregate the data at the level business unit or at the level of legal entity or at the level of risk type or at the level of business vertical. In one example, the risk computation module 120 may perform or execute various ET jobs to aggregate the data.

Thereafter, the data model generator 126 loads the aggregated data into a solvency data mart which is designed specifically for Solvency II reporting. In one example, the data model generator 126 processes the solvency data mart to transform the raw input and output of the risk calculation into a Solvency II reporting model that is designed for the Solvency II reporting. In some embodiments, the Solvency II reporting model is may be based on the subject areas identified by the reporting requirements, such as balance sheet, premiums, claims, expenditure, own funds, participation structure, change analysis, minimum capital requirement (MCR) and a solvency capital requirement (SCR), assets, technical provisions, reinsurance and profit or loss sharing. The categorization of the reports based on its subject area supports efficient risk calculations and parallel reporting in a faster manner. Further, iterative calculations and reporting for individual subject areas can be accomplished.

In some embodiments, the data model generator 126 generates a schematic layer on top of the solvency data mart to provide the end users to generate ad-hoc reports. The schematic layer provides the dimensions and fact attributes from the solvency data mart.

Thereafter, the report generation module 122 generates Solvency II reports, from the schematic layer. In some embodiments, the report generation module 122 generates Solvency II reports based on the templates provided by the end users and/or by the regulators. In some embodiments, the report generation module 122 may retrieve the templates, from the report template repository 132, to generate the Solvency II reports. In one example, the generated reports may have multiple tabs, wherein each tab represents the individual subject areas. In one example, the solvency compliance computing device converts the generated report(s) into an eXtensible Business Reporting Language (XBRL) format for public disclosure. In one example, the report generation module 122 may store the solvency reports in the solvency reports repository 134.

It will be understood by the reader that with time, the Solvency II regulations may undergo amendments, or a new regulation may be adopted by a jurisdiction or a jurisdiction, which previously did not have solvency compliance regulations, may now adopt and enact the same. Due to changes in the solvency compliance regulations, the template of the reporting may change, data which was previously not subjected to risk may now be subjected to risk and so on.

In one example, the regulation update module 128 generates various interfaces and prompts the end user to enter a new set of solvency rules, wherein the new set of solvency rules is associated with the jurisdiction. In case, the regulations for the jurisdiction is already defined in the solvency rules repository 132, the regulation update module 128 updates an existing set of solvency rules with the new set of solvency rules. In case, the regulations for the jurisdiction are not defined in the solvency rules repository 132, the regulation update module 128 stores the new set of solvency rules. Thereafter, the regulation update module 128 updates at least one of the solvency gateway checks or the risk computation rules, based on the new set of solvency rules. In various examples, the regulation update module 128 may also at least one of generate or update the template provided by a regulator of the jurisdiction; and instruct the report generation module 122 to generate a solvency compliance report based on the at least one of the generated or updated template.

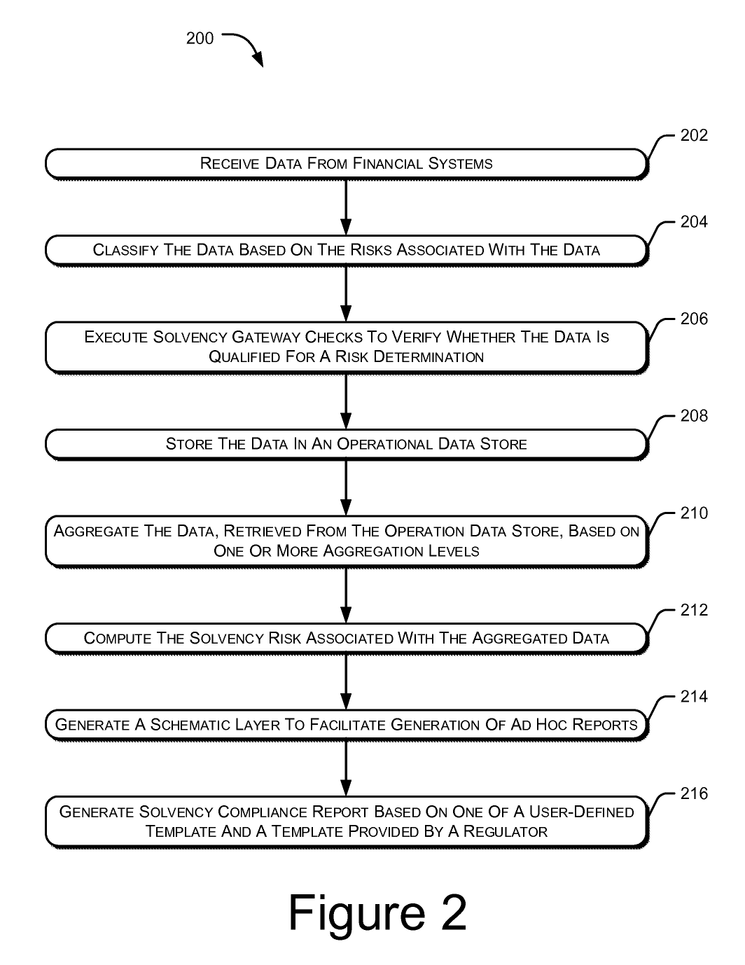

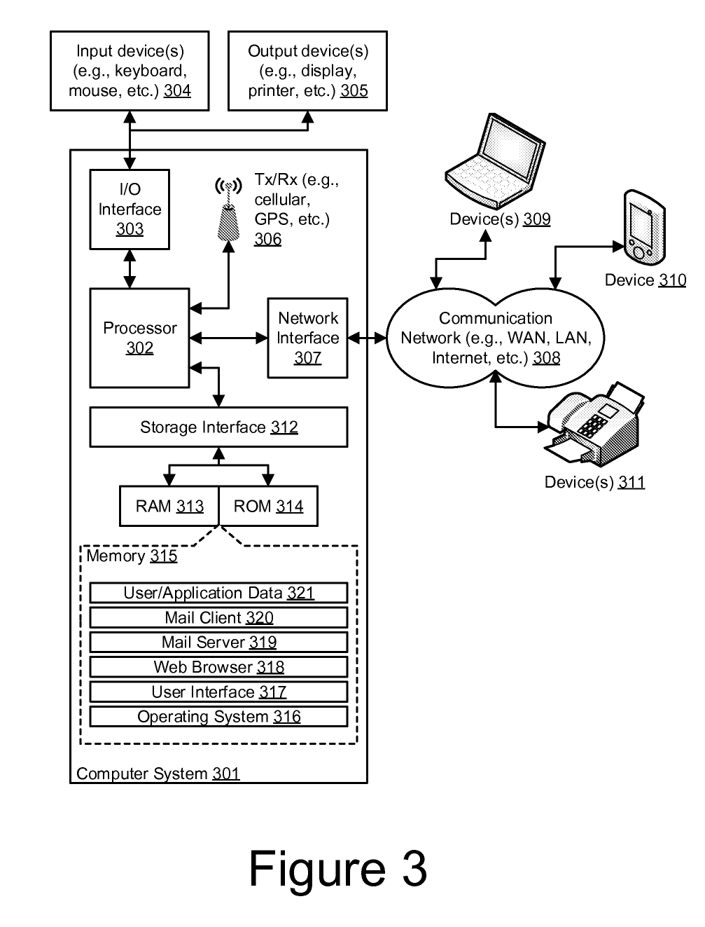

Thus, the solvency compliance computing device 102 provides for compliance with solvency regulations of one or more jurisdictions. The detailed working of the solvency compliance computing device 102 for compliance with solvency regulations of one or more jurisdictions is further explained in conjunction with the FIGS. 2-3.

FIG. 2, illustrate exemplary computer implemented method 200 complying with solvency regulations of one or more jurisdictions, according to an embodiment of the present subject matter. The method 200 may be described in the general context of computer executable instructions. Generally, computer executable instructions can include routines, programs, objects, components, data structures, procedures, modules, and functions, which perform particular functions or implement particular abstract data types. The method 200 may also be practiced in a distributed computing environment where functions are performed by remote processing devices that are linked through a communication network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method 200 or alternative methods. Additionally, individual blocks may be deleted from the method 200 without departing from the spirit and scope of the subject matter described herein. Furthermore, the method 200 can be implemented in any suitable hardware, software, firmware, or combination thereof.

With reference to method 200 as depicted in FIG. 2, as shown in block 202, data is received from the financial systems. In some examples, the data integration module 118 of the solvency compliance computing device 102 obtains data from various financial systems of the organization and/or from third parties, such as investment partners. In one example, the data integration module 118 may access the data repositories associated with the various financial systems to retrieve the data.

As illustrated in block 204, the data is classified based on the risks associated with the data. In some examples, the data classification module 124 classifies or segregates the data based on the type of risks associated for the solvency compliance. In one example, the data classification module 124 may generate various extract, transform, and load (ETL) jobs that may provide the interface to segregate the data based on the type of risks, such as market risks, counterparty default risk, life underwriting, non-life underwriting risk, health underwriting risk, operation risk, and asset liability management risk.

As depicted in block 206, solvency gateway checks are executed to verify whether the data qualifies for a risk determination. In some examples, the risk computation module 120 executes the solvency gateway checks, such as to calculate the credit risk, probability of default parameter cannot be null. In some embodiments, the risk computation module 120 verifies the data against the Solvency II compliance rules, stored in the solvency rules repository 130, to check if the data is qualified for a risk calculation.

At block 208, the data is stored in an operational data store. In some examples, the data model generator 126 stores the data, which is subject to risks as determined by the solvency gateway checks, in operational data store, which may be stored in the operational data storage 136.

As shown in block 210, the data is retrieved from the operation data store and aggregated based on one or more aggregation levels. In some examples, the risk computation module 120 aggregates the data in the operational data storage at various aggregation levels. In various examples, the risk computation module 120 may aggregate the data at the level business unit or at the level of legal entity or at the level of risk type or at the level of business vertical.

As illustrated in block 212, the solvency risk, associated with the aggregated data, is computed. In some examples, the data model generator 126 loads the aggregated data into a solvency data mart which is designed specifically for Solvency II reporting. In one example, the data model generator 126 processes the solvency data mart to transform the raw input and output of the risk calculation into a Solvency II reporting model that is designed for the Solvency II reporting.

As depicted in block 214, a schematic layer, to facilitate generation of ad hoc reports, is generated. In some examples, the data model generator 126 generates a schematic layer on top of the solvency data mart to provide the end users to generate ad-hoc reports.

At block 216, a solvency compliance report is generated based on one of a user-defined template and a template provided by a regulator. In some examples, the report generation module 122 generates Solvency II reports, from the schematic layer. In some embodiments, the report generation module 122 generates Solvency II reports based on the templates provided by the end users and/or by the regulators. In some embodiments, the report generation module 122 may retrieve the templates, from the report template repository 132, to generate the Solvency II reports. In one example, the generated reports may have multiple tabs, wherein each tab represents the individual subject areas.

Example of a Solvency compliance computing device

FIG. 3 is a block diagram of an example of a solvency compliance computing device 301. Although a solvency compliance computing device 301 is illustrated and described herein, other variations of computer systems may be used. Solvency compliance computing device 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the solvency compliance computing device 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 318-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the solvency compliance computing device 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the solvency compliance computing device 301 may itself embody one or more of these devices.

In some embodiments, the processor 302 may be disposed in communication with one or more memory devices (e.g., RAM 413, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the solvency compliance computing device 301. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the solvency compliance computing device 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the solvency compliance computing device 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol); secure sockets layer (SSL), Transport Layer Security (TLS), etc. Web browsers may utilize facilities such as AJAX, DHTML, Adobe Flash, JavaScript, Java; application programming interfaces (APIs), etc. In some embodiments, the solvency compliance computing device 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the solvency compliance computing device 301 may implement a mail client 320 stored program component. The mail client may be a mail viewing application, such as Apple Mail, Microsoft Entourage, Microsoft Outlook, Mozilla Thunderbird, etc.

In some embodiments, solvency compliance computing device 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described devices, methods, and non-transitory computer readable media for complying with solvency regulations of one or more jurisdictions. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A solvency compliance computing device comprising:
a processor;
a memory communicatively coupled to the processor, wherein the memory stores processor-executable instructions, which when executed by the processor, cause the processor to perform steps comprising:
classifying financial data based on a type of risk associated with the data;
performing solvency gateway checks, based on solvency rules, to determine validity of the classified data for determination of risk;
aggregating the validated data based on at least one aggregation level; and
computing a solvency risk, based on risk computation rules, associated with the aggregated data.

2. The device as claimed in claim 1, wherein the processor-executable instructions, when executed by the processor, further cause the processor to perform steps further comprising:
generating a schematic layer to facilitate generation of schematic reports, based on the computed solvency risk.

3. The device as claimed in claim 1, wherein the processor-executable instructions, when executed by the processor, further cause the processor to perform steps further comprising:
generating a solvency compliance report based on at least one of a user-defined template or a template provided by a regulator of the one or more jurisdictions.

4. The device as claimed in claim 1, wherein the classifying the financial data further comprises:
grouping the data into at least one of data subjected to market risk, data subjected to counterparty default risk, data subjected to life underwriting risk, data subjected to non-life underwriting risk, data subjected to health underwriting risk, data subjected to operation risk, asset liability management risk, ord data subjected to market consistent balance sheet.

5. The device as claimed in claim 1, wherein the processor-executable instructions, when executed by the processor, further cause the processor to perform steps further comprising:
receiving a new set of solvency rules, wherein the new set of solvency rules is associated with the jurisdiction;
updating an existing set of solvency rules with the new set of solvency rules on determining solvency compliance requirements of the jurisdiction to be already defined in the system;
storing the new set of solvency rules on determining solvency compliance requirements of the jurisdiction not to be defined in the system; and
updating at least one of the solvency gateway checks or the risk computation rules, based on the new set of solvency rules.

6. The device as claimed in claim 5, wherein the processor-executable instructions, when executed by the processor, further cause the processor to perform steps further comprising:
at least one of generating or updating the template provided by a regulator of the jurisdiction; and
generating a solvency compliance report based on the at least one of the generated or updated template.

7. A method for complying with solvency regulations of one or more jurisdictions, the method comprising:
classifying, by a solvency compliance computing device, financial data based on a type of risk associated with the data;
performing, by the solvency compliance computing device, solvency gateway checks, based on solvency rules, to determine validity of the classified data for determination of risk;
aggregating, by the solvency compliance computing device, the validated data based on at least one aggregation level; and
computing, by the solvency compliance computing device, a solvency risk, based on risk computation rules, associated with the aggregated data.

8. The method as claimed in claim 7, wherein the method further comprises:
generating, by the solvency compliance computing device, a schematic layer to facilitate generation of schematic reports, based on the computed solvency risk:

9. The method as claimed in claim 7, wherein the method further comprises:
generating, by the solvency compliance computing device, a solvency compliance report based on at least one of a user-defined template or a template provided by a regulator of the one or more jurisdictions.

10. The method as claimed in claim 7, wherein the classifying further comprises:
grouping, by the solvency compliance computing device, the data into at least one of data subjected to market risk, data subjected to counterparty default risk, data subjected to life underwriting risk, data subjected to non-life underwriting risk, data subjected to health underwriting risk, data subjected to operation risk, asset liability management risk, ord data subjected to market consistent balance sheet.

11. The method as claimed in claim 7, wherein the method further comprises:
receiving, by the solvency compliance computing device, a new set of solvency rules, wherein the new set of solvency rules is associated with the jurisdiction;
updating, by the solvency compliance computing device, an existing set of solvency rules with the new set of solvency rules on determining solvency compliance requirements of the jurisdiction to be already defined in the system;
storing, by the solvency compliance computing device, the new set of solvency rules on determining solvency compliance requirements of the jurisdiction not to be defined in the system; and
updating, by the solvency compliance computing device, at least one of the solvency gateway checks or the risk computation rules, based on the new set of solvency rules.

12. The method as claimed in claim 7, wherein the method further comprises:
at least one of generating or updating, by the solvency compliance computing device, the template provided by a regulator of the jurisdiction; and
generating, by the solvency compliance computing device, a solvency compliance report based on the at least one of the generated or updated template.

13. A non-transitory computer readable medium for complying with solvency regulations of one or more jurisdictions comprising processor executable instructions, which when executed by a processor cause the processor to perform steps comprising:
classifying financial data based on a type of risk associated with the data;
performing solvency gateway checks, based on solvency rules, to determine validity of the classified data for determination of risk;
aggregating the validated data based on at least one aggregation level; and
computing a solvency risk, based on risk computation rules, associated with the aggregated data.

14. The medium as claimed in claim 13, wherein the processor executable instructions, when executed by the processor, further cause the processor to perform steps further comprising:
generating a schematic layer to facilitate generation of schematic reports, based on the computed solvency risk.

15. The medium as claimed in claim 13, wherein the processor executable instructions, when executed by the processor, further cause the processor to perform steps further comprising:
generating a solvency compliance report based on at least one of a user-defined template or a template provided by a regulator of the one or more jurisdictions.

16. The device as claimed in claim 13, wherein the classifying the financial data further comprises:
grouping the data into at least one of data subjected to market risk, data subjected to counterparty default risk, data subjected to life underwriting risk, data subjected to non-life underwriting risk, data subjected to health underwriting risk, data subjected to operation risk, asset liability management risk, ord data subjected to market consistent balance sheet.

17. The device as claimed in claim 13, wherein the processor executable instructions, when executed by the processor, further cause the processor to perform steps further comprising:
receiving a new set of solvency rules, wherein the new set of solvency rules is associated with the jurisdiction;
updating an existing set of solvency rules with the new set of solvency rules on determining solvency compliance requirements of the jurisdiction to be already defined in the system;
storing the new set of solvency rules on determining solvency compliance requirements of the jurisdiction not to be defined in the system; and
updating at least one of the solvency gateway checks or the risk computation rules, based on the new set of solvency rules.

18. The device as claimed in claim 17, wherein the processor executable instructions, when executed by the processor, further cause the processor to perform steps further comprising:
at least one of generating or updating the template provided by a regulator of the jurisdiction; and
generating a solvency compliance report based on the at least one of the generated or updated template.
